(19) United States
(12) Patent Application Publication
(10) Pub. No.: US 2025/0243853 A1
(43) Pub. Date: Jul. 31, 2025

(54) PUMP ASSEMBLY FOR ORAL IRRIGATOR

(71) Applicant: SHENZHEN BESMAN ELECTRONIC TECHNOLOGY CO.,LTD, SHENZHEN (CN)

(72) Inventor: XUEWU WANG, SHENZHEN (CN)

(21) Appl. No.: 18/650,340

(22) Filed: Apr. 30, 2024

(30) Foreign Application Priority Data
Jan. 31, 2024 (CN) 202420227611.9

(51) Int. Cl. F04B 19/04; A61C 17/024; F04B 17/03; F04B 53/10; F04B 53/14

(52) U.S. Cl. CPC F04B 19/04; A61C 17/024; F04B 17/03; F04B 53/10; F04B 53/144

(57) ABSTRACT

A pump assembly for an oral irrigator is provided. The pump assembly for the oral irrigator includes a housing. The housing includes a front housing and a rear housing, the front housing and the rear housing are connected and are covered with each other, an accommodating cavity is defined between the front housing and the rear housing. The accommodating cavity includes a pump body accommodating cavity, a fluted disk accommodating cavity, and a motor accommodating cavity. The pump body accommodating cavity, the fluted disk accommodating cavity, and the motor accommodating cavity are sequentially defined in a vertical direction. The pump body is disposed in the pump body accommodating cavity, an eccentric fluted disk is disposed in the fluted disk accommodating cavity, and a driving motor is disposed in the motor accommodating cavity.

### TECHNICAL FIELD

The present disclosure relates to a technical field of pumps, and in particular to a pump assembly for an oral irrigator.

### BACKGROUND

Oral irrigators are one kind of household oral cleaning device, and a main principle of which is to remove dental plaque and food remaining below gum lines using a pulsed water flow. Electric oral irrigators on the market each is generally provided with a motor to drive a reciprocating piston pump, a high-speed rotation force of the motor drives an eccentric device to push a piston to reciprocate in a vertical direction, so as to open and close an inlet valve and an outlet valve. In this way, a pump body sucks and sprays a high-pressure water flow for effectively cleaning teeth and diastemata.

In the prior art, a case and the piston of the reciprocating piston pump are generally made of plastic, the case and the piston move at high speed while working, casing large friction therebetween, and the reciprocating piston pump is quickly abraded, so that sealing performance and a service life of the reciprocating piston pump are affected, in order to effectively avoid the reciprocating piston pump from abrading, an inner wall of the reciprocating piston pump in a stroke range of the piston is made of a metal material.

For example, a Chinese utility model patent No. CN204971669U discloses an oral irrigator, in which an inner wall of a second chamber is made of metal, so that impermeability and smoothness of the oral irrigator are better and the oral irrigator is more stable. Specifically, a metal sleeve and the second chamber are placed into a mold for secondary injection molding to form a pump having a metal inner wall, since a case of the pump and the metal sleeve are made of different materials and the metal sleeve has a smooth outer surface, the metal sleeve easily falls off from the pump case, and there is also water seepage occurring between the pump case and the metal sleeve, impermeability of which is not good enough, so as to affect the impermeability and a service life of the oral irrigator.

For another example, a Chinese utility model patent No. CN214660801U discloses a pump of an oral irrigator and the oral irrigator, in which a second connection portion of a metal sleeve includes a first groove, a first connection portion of a chamber is a first protrusion fitted in the first groove, however, even though such structure solves a defect that the metal sleeve easily falls off from a case of the pump, the metal sleeve still needs to be fixed through cooperation of the groove and the protrusion, which is relatively difficult in assembly, and fixation is generally completed through injection molding. Meanwhile, since the case of the pump and the metal sleeve are made of two different materials, defective products are easily caused during injection molding.

### SUMMARY

The present disclosure aims to provide a pump assembly for an oral irrigator, in which a steel sleeve is disposed in a pump cavity to effectively improve a lubrication degree of a pump body during working and prolong a service life of the pump body, the steel sleeve is fixedly connected to a pump housing using a knurled rough surface being uniform and rough with a glue, which is not only low in production and assembly difficult, but also stable in connection, so that durability is achieved and problems proposed in the background are achieved.

In order to achieve above aims, the present disclosure provides technical solutions as follows.

The present disclosure provides the pump assembly for the oral irrigator, including a housing. The housing includes a front housing and a rear housing, the front housing and the rear housing are connected and are covered with each other, an accommodating cavity is defined between the front housing and the rear housing. The accommodating cavity includes a pump body accommodating cavity, a fluted disk accommodating cavity, and a motor accommodating cavity. The pump body accommodating cavity, the fluted disk accommodating cavity, and the motor accommodating cavity are sequentially defined in a vertical direction. The pump body is disposed in the pump body accommodating cavity, an eccentric fluted disk is disposed in the fluted disk accommodating cavity, and a driving motor is disposed in the motor accommodating cavity. The driving motor is connected to the eccentric fluted disk and drives the eccentric fluted disk, the eccentric fluted disk is connected to the pump body through a connecting rod and drives the pump body. The pump body includes the pump housing, the pump cavity is defined in the pump housing, a metal sleeve is disposed in the pump cavity. The knurled rough surface is disposed on an outer wall of the metal sleeve, a rough surface is disposed on an inner wall of the pump cavity, the rough surface is at least partially overlapped with the knurled rough surface, and an inner wall surface of the metal sleeve is a smooth wall surface.

Furthermore, the pump body includes a piston assembly, a first end of the piston assembly is connected to the connecting rod, and a second end of the piston assembly is inserted into the pump cavity and is slidably connected to the metal sleeve.

Furthermore, the piston assembly includes a piston base and a piston, the piston is disposed at one end of the piston base away from the connecting rod.

Furthermore, the metal sleeve is the steel sleeve.

Furthermore, the pump body includes a water inlet and a water outlet, a water inlet pipe is connected to the water inlet, a water inlet valve plate is clamped between the water inlet pipe and the water inlet, and a water outlet valve is connected to the water outlet.

Furthermore, the water outlet valve is a duckbill valve.

Furthermore, a water outlet connector is connected to an upper end of the water outlet, and the water outlet connector covers a periphery of the water outlet valve.

Furthermore, ring gear teeth are disposed on the eccentric fluted disk, a driving gear is disposed on an output shaft of the driving motor, and the driving gear is engaged with the ring gear teeth.

Furthermore, the knurled rough surface is a texture having regular patterns.

Beneficial effects of the present disclosure are as follows.

According to the present disclosure, the steel sleeve is disposed in the pump cavity to effectively improve the lubrication degree of the pump body during working and prolong the service life of the pump body, the steel sleeve is fixedly connected to the pump housing using the knurled rough surface being uniform and rough with the glue, which is not only low in production and assembly difficult, but also stable in connection, so that the durability is achieved.

### BRIEF DESCRIPTION OF DRAWINGS

FIG. 1 is a first exploded structural schematic diagram of the present disclosure.

FIG. 2 is a second exploded structural schematic diagram of the present disclosure.

FIG. 3 is a first structural schematic diagram of the present disclosure.

FIG. 4 is a second structural schematic diagram of the present disclosure.

Reference numerals in the drawings: 1. front housing; 11. pump body accommodating cavity; 12. fluted disk accommodating cavity; 13. motor accommodating cavity; 2. water outlet connector; 3. pump body; 31. water outlet valve; 32. pump housing; 321. water inlet; 322. water outlet; 33. metal sleeve; 331. knurled rough surface; 34. water inlet valve plate; 35. piston assembly; 351. piston; 352. piston base; 4. eccentric fluted disk; 5. connecting rod; 6. driving motor; 61. driving gear; 7. rear housing; 8. water inlet pipe.

### DETAILED DESCRIPTION OF EMBODIMENTS

Technical solutions in embodiments of the present disclosure are clearly and completely described below with reference to accompanying drawings in the embodiments of the present disclosure. All other embodiments obtained by those who skilled in the art based on the embodiments of the present disclosure without creative efforts shall fall within a protection scope of the present disclosure.

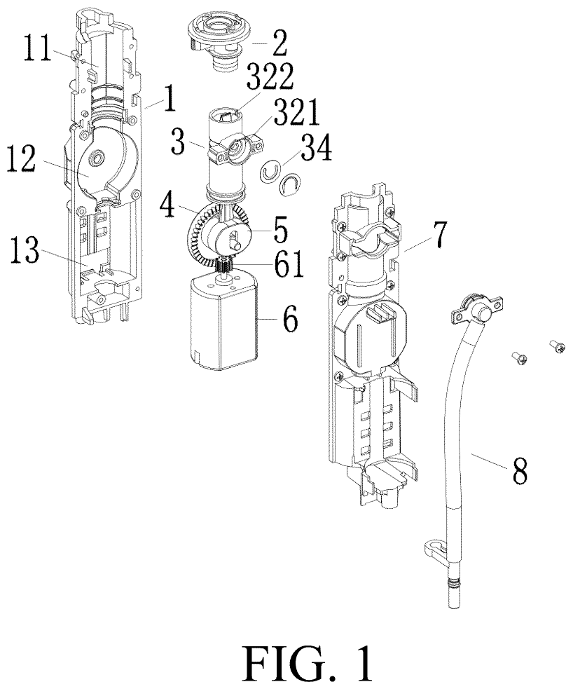

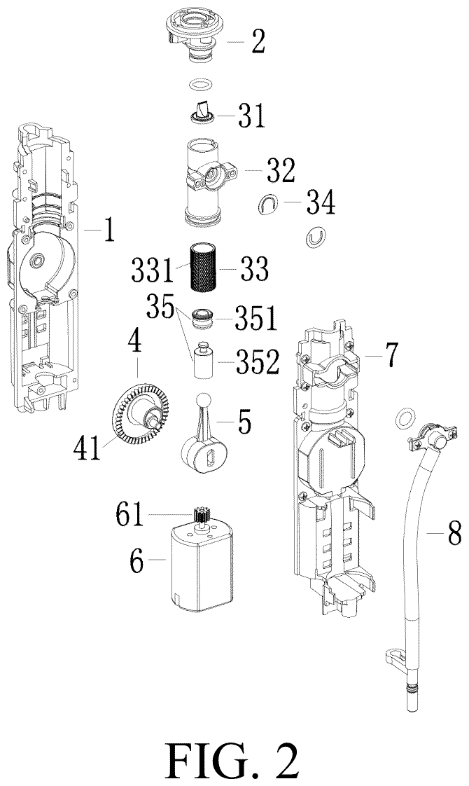

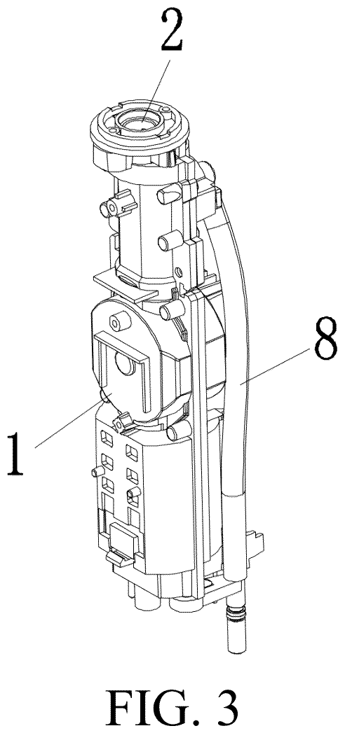

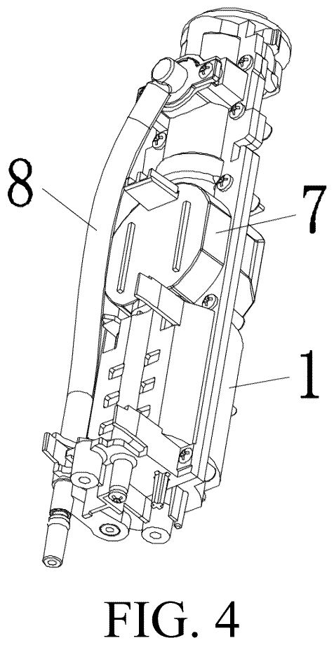

Referring to FIGS. 1-4, the present disclosure provides a pump assembly for an oral irrigator, including a housing. The housing includes a front housing 1 and a rear housing 7, the front housing 1 and the rear housing 7 are connected and are covered with each other, an accommodating cavity is defined between the front housing 1 and the rear housing 7. The accommodating cavity includes a pump body accommodating cavity 11, a fluted disk accommodating cavity 12, and a motor accommodating cavity 13. The pump body accommodating cavity 11, the fluted disk accommodating cavity 12, and the motor accommodating cavity 13 are sequentially defined in a vertical direction. The pump body 3 is disposed in the pump body accommodating cavity 11, an eccentric fluted disk 4 is disposed in the fluted disk accommodating cavity 12, and a driving motor 6 is disposed in the motor accommodating cavity 13. The driving motor 6 is connected to the eccentric fluted disk 4 and drives the eccentric fluted disk 4, ring gear teeth 41 are disposed on the eccentric fluted disk 4, a driving gear 61 is disposed on an output shaft of the driving motor 6, and the driving gear 61 is engaged with the ring gear teeth 41. The eccentric fluted disk 4 is connected to the pump body 3 through a connecting rod 5 and drives the pump body 3. The pump body 3 includes a pump housing 32 and a piston assembly 35, a pump cavity is defined in the pump housing 32, a metal sleeve 33 is disposed in the pump cavity, a first end of the piston assembly 35 is connected to the connecting rod 5, and a second end of the piston assembly 35 is inserted into the pump cavity and is slidably connected to the metal sleeve 33. The piston assembly 35 includes a piston base 352 and a piston 351, the piston 351 is disposed at one end of the piston base 352 away from the connecting rod 5. The metal sleeve 33 is a steel sleeve. A knurled rough surface is disposed on an outer wall of the metal sleeve 33, the knurled rough surface 331 is formed by grinding by a lathe, or formed by laser engraving, in one embodiment, the knurled rough surface 331 is a texture having regular patterns, so that a processing process thereof is automated and the knurled rough surface 331 is processed to be relatively uniform, thereby ensuring stability of a shape of the steel sleeve and further improving a degree of precision of the pump cavity. A rough surface is disposed on an inner wall of the pump cavity, the rough surface is at least partially overlapped with the knurled rough surface 331, a glue is selected to cooperate with the rough surface and the knurled rough surface when assembling to achieve better fixing effect. An inner wall surface of the metal sleeve 33 is a smooth wall surface.

The pump body 3 includes a water inlet 321 and a water outlet 322, a water inlet pipe 8 is connected to the water inlet 321, a water inlet valve plate 34 is clamped between the water inlet pipe 8 and the water inlet 321, and a water outlet valve 31 is connected to the water outlet 322. The water outlet valve 31 is a duckbill valve. A water outlet connector 2 is connected to an upper end of the water outlet 322, the water outlet connector 2 covers a periphery of the water outlet valve 31, and the water outlet connector 3 is configured to connect to an external water supply device.

According to the present disclosure, the steel sleeve is disposed in the pump cavity to effectively improve a lubrication degree of the pump body 3 during working and prolong the service life of the pump body 3, the steel sleeve is fixedly connected to the pump housing 32 using the knurled rough surface 331 being uniform and rough with the glue, which is not only low in production and assembly difficult, but also stable in connection, so that durability is achieved.

It should be noted that, in the specification, relational terms, such as first and second, are merely used to distinguish one entity or operation from another entity or operation, and do not necessarily require or imply that there is any actual relationship or order between these entities or operations. Moreover, terms, such as “include”, “comprise” or any other variations thereof are intended to cover a non-exclusive inclusion, so that a process, method, article, or device that includes a series of elements not only includes those elements, but also includes other elements not explicitly listed, or further includes elements inherent to the process, method, article, or device.

Although the embodiments of the present disclosure have been shown and described, those who skilled in the art can understand that various changes, modifications, substitutions and variations can be made to these embodiments without departing from a principle and spirit of the present disclosure, and a scope of the present disclosure is defined by appended claims and their equivalents.

What is claimed is:

1. A pump assembly for an oral irrigator, comprising:
a housing;
wherein the housing comprises a front housing and a rear housing, the front housing and the rear housing are connected and are covered with each other, an accommodating cavity is defined between the front housing and the rear housing; the accommodating cavity comprises a pump body accommodating cavity, a fluted disk accommodating cavity, and a motor accommodating cavity; the pump body accommodating cavity, the fluted disk accommodating cavity, and the motor accommodating cavity are sequentially defined in a vertical direction; a pump body is disposed in the pump body accommodating cavity, an eccentric fluted disk is disposed in the fluted disk accommodating cavity, and a driving motor is disposed in the motor accommodating cavity; the driving motor is connected to the eccentric fluted disk and drives the eccentric fluted disk, the eccentric fluted disk is connected to the pump body through a connecting rod and drives the pump body; the pump body comprises a pump housing, a pump cavity is defined in the pump housing, a metal sleeve is disposed in the pump cavity; a knurled rough surface is disposed on an outer wall of the metal sleeve, a rough surface is disposed on an inner wall of the pump cavity, the rough surface is at least partially overlapped with the knurled rough surface; and an inner wall surface of the metal sleeve is a smooth wall surface.

2. The pump assembly for the oral irrigator according to claim 1, wherein the pump body comprises a piston assembly, a first end of the piston assembly is connected to the connecting rod, and a second end of the piston assembly is inserted into the pump cavity and is slidably connected to the metal sleeve.

3. The pump assembly for the oral irrigator according to claim 2, wherein the piston assembly comprises a piston base and a piston, the piston is disposed at one end of the piston base away from the connecting rod.

4. The pump assembly for the oral irrigator according to claim 1, wherein the metal sleeve is a steel sleeve.

5. The pump assembly for the oral irrigator according to claim 1, wherein the pump body comprises a water inlet and a water outlet, a water inlet pipe is connected to the water inlet, a water inlet valve plate is clamped between the water inlet pipe and the water inlet, and a water outlet valve is connected to the water outlet.

6. The pump assembly for the oral irrigator according to claim 5, wherein the water outlet valve is a duckbill valve.

7. The pump assembly for the oral irrigator according to claim 5, wherein a water outlet connector is connected to an upper end of the water outlet, and the water outlet connector covers a periphery of the water outlet valve.

8. The pump assembly for the oral irrigator according to claim 1, wherein ring gear teeth are disposed on the eccentric fluted disk, a driving gear is disposed on an output shaft of the driving motor, and the driving gear is engaged with the ring gear teeth.

9. The pump assembly for the oral irrigator according to claim 1, wherein the knurled rough surface is a texture having regular patterns.
